(19) United States
(12) Patent Application Publication
(10) Pub. No.: US 2026/0288607 A1
(43) Pub. Date: Sep. 24, 2026

(54) STORAGE MEDIUM, MAGNETIC DISK DEVICE, AND DATA CENTER SYSTEM

(71) Applicants: KABUSHIKI KAISHA TOSHIBA, Kawasaki-shi (JP); Toshiba Electronic Devices & Storage Corporation, Kawasaki-shi (JP)

(72) Inventors: Hiroshi Sugiyama, Yokohama Kanagawa (JP); Takuya Amemiya, Tachikawa Tokyo (JP)

(21) Appl. No.: 19/368,642

(22) Filed: Oct. 24, 2025

(30) Foreign Application Priority Data
Mar. 21, 2025 (JP) 2025-046686

(51) Int. Cl. G06F 11/20; G11B 20/18

(52) U.S. Cl. CPC G06F 11/2092; G11B 20/18

(57) ABSTRACT

According to one embodiment, a storage medium stores a program for causing a computer to: execute first processing of determining whether there is a failure in a magnetic disk device based on log information of the magnetic disk device; in a case where it is determined in the first processing that the magnetic disk device has failed, execute second processing of determining whether the magnetic disk device is continuously used by depopulation processing; and determine a treatment of the magnetic disk device based on results of the first processing and the second processing.

### CROSS-REFERENCE TO RELATED APPLICATIONS

This application is based upon and claims the benefit of priority from Japanese Patent Application No. 2025-046686, filed Mar. 21, 2025, the entire contents of which are incorporated herein by reference.

### FIELD

Embodiments described herein relate generally to a storage medium, a magnetic disk device, and a data center system.

### BACKGROUND

A data center system including a host and a plurality of magnetic disk devices managed by the host is known. The data center provides a storage area of the plurality of magnetic disk devices to a client. When an anomaly of the magnetic disk device is detected in the data center system, the magnetic disk device is virtually separated from the host before being physically separated (removed).

### BRIEF DESCRIPTION OF THE DRAWINGS

FIG. 1 is a block diagram illustrating an example of a configuration of a data center system according to an embodiment.

FIG. 2 is a block diagram illustrating an example of a hardware configuration of a magnetic disk device included in the data center system according to the embodiment.

FIG. 3 is a cross-sectional view illustrating an example of a relationship between a magnetic disk and a magnetic head included in the magnetic disk device according to the embodiment.

FIG. 4 is a diagram illustrating an example of a data structure of log information stored in the magnetic disk device according to the embodiment.

FIG. 5 is a block diagram illustrating an example of a hardware configuration of a host included in the data center system according to the embodiment.

FIG. 6 is a block diagram illustrating an example of a functional configuration of the host included in the data center system according to the embodiment.

FIG. 7 is a flowchart illustrating an example of a series of processing executed when an anomaly is detected in the host included in the data center system according to the embodiment.

FIG. 8 is a flowchart illustrating an example of determination processing in the data center system according to the embodiment.

FIG. 9 is a block diagram illustrating an example of a functional configuration of a magnetic disk device included in a data center system according to a modification.

FIG. 10 is a flowchart illustrating an example of a series of processing executed when an anomaly is detected in a host included in a data center system according to the modification.

### DETAILED DESCRIPTION

In general, according to one embodiment, a storage medium stores a program for causing a computer to: execute first processing of determining whether there is a failure in a magnetic disk device based on log information of the magnetic disk device; in a case where it is determined in the first processing that the magnetic disk device has failed, execute second processing of determining whether the magnetic disk device is continuously used by depopulation processing; and determine a treatment of the magnetic disk device based on results of the first processing and the second processing.

Hereinafter, embodiments will be described with reference to the drawings. Note that, in the following description, components having the same function and configuration are denoted by the same reference numerals.

### 1. Configuration

### 1.1 Data center system

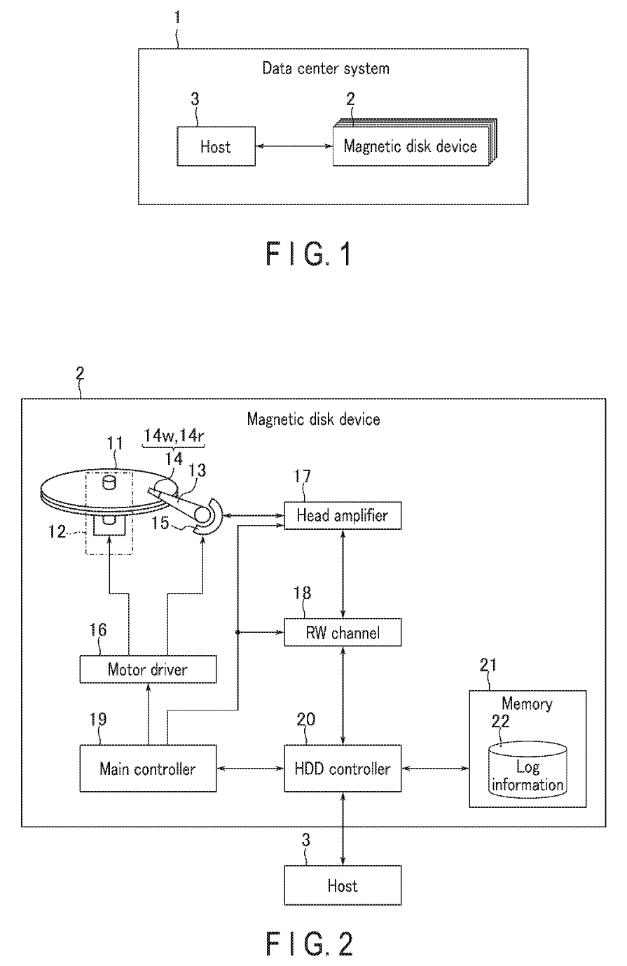

FIG. 1 is a block diagram illustrating an example of a configuration of a data center system according to an embodiment.

A data center system 1 is a system that provides a client with a storage area for storing data. As illustrated in FIG. 1, the data center system 1 includes, for example, a plurality of magnetic disk devices 2 and a host 3.

Each of the plurality of magnetic disk devices 2 is a storage device that stores data in a nonvolatile manner based on the magnetization of a magnetic material. Each of the plurality of magnetic disk devices 2 is, for example, a hard disk drive (HDD).

The host 3 is a server or a personal computer in the data center system 1. The host 3 controls the operation of the plurality of magnetic disk devices 2 using a command. For example, the host 3 writes data to the plurality of magnetic disk devices 2. The host 3 reads data from the plurality of magnetic disk devices 2.

In addition, the host 3 manages operation status of the plurality of magnetic disk devices 2. For example, in a case where any anomaly is detected in a certain magnetic disk device 2, the host 3 is configured to execute determination processing without physically separating the magnetic disk device 2 in which the anomaly is detected. The determination processing includes, for example, determining the presence or absence of a failure in the target magnetic disk device 2, further determining whether the target magnetic disk device 2 can be continuously used by logical depopulation processing in a case where it is determined that the target magnetic disk device 2 has failed, and determining treatment of the magnetic disk device 2 based on these determination results. The host 3 notifies an operator of the data center system 1 of a result of the determination processing. Hereinafter, the logical depopulation processing may also be referred to as depopulation processing or Depop processing.

### 1.2 Magnetic disk device

FIG. 2 is a block diagram illustrating an example of a hardware configuration of the magnetic disk device included in the data center system according to the embodiment. FIG. 2 illustrates a hardware configuration of one of the plurality of magnetic disk devices 2 mounted in the data center system 1. Note that the plurality of magnetic disk devices 2 mounted in the data center system 1 may have the same configuration.

As illustrated in FIG. 2, the magnetic disk device 2 includes, for example, a magnetic disk 11, a spindle motor 12, an arm 13, a magnetic head 14, a voice coil motor 15, a motor driver 16, a head amplifier 17, a read-write (RW) channel 18, a main controller 19, an HDD controller 20, and a memory 21.

The magnetic disk 11 is a disk-shaped storage medium capable of storing data in a nonvolatile manner. The magnetic disk 11 has, for example, a configuration in which a magnetic body (magnetic material) is sputtered on a surface of a platter made of a non-magnetic material. The surface on which the magnetic body is sputtered corresponds to a recording surface of the magnetic disk 11. The recording surface of the magnetic disk 11 may be on one side or both sides. The magnetic disk device 2 may include one or more magnetic disks 11.

The spindle motor 12 is a device that rotates the magnetic disk 11. The spindle motor 12 includes a rotation shaft and a driver. The rotation shaft holds a central portion of the magnetic disk 11. The driver is configured to drive the rotation shaft to rotate the rotation shaft. The magnetic disk 11 may rotate about the rotation shaft by the rotation of the rotation shaft.

The arm 13 is a component that holds the magnetic head 14. The arm 13 has, for example, a rod-like shape and holds the magnetic head 14 at a tip of the arm 13.

The magnetic head 14 is a component for writing data to the magnetic disk 11 and reading data from the magnetic disk 11. The magnetic head 14 floats to a position slightly away from the recording surface of the magnetic disk 11 by the arm 13. The magnetic head 14 includes a write element 14wand a read element 14r.

The write element 14w writes write data by changing a magnetization state of a target area of the magnetic disk 11 for data writing. The write data is data to be stored in a write target area. The write element 14w receives a write current and changes the magnetization of the write target area based on the write current.

The read element 14r generates a read signal based on data stored in the read target area based on a magnetization state of the read element 14r and a magnetization state of a read target area of the data of the magnetic disk 11.

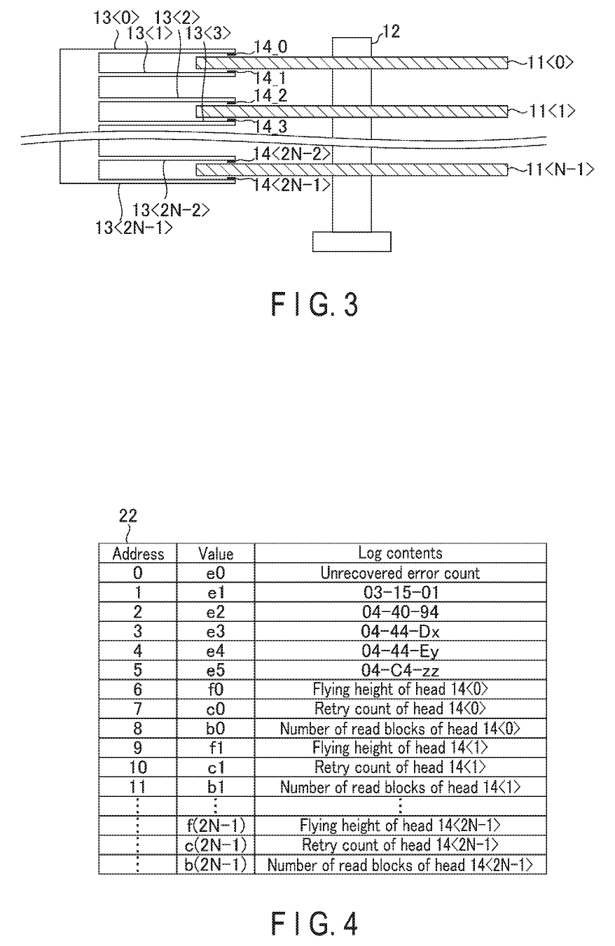

FIG. 3 is a cross-sectional view illustrating an example of a relationship between the magnetic disk and the magnetic head included in the magnetic disk device according to the embodiment. The example of FIG. 3 shows a case where the magnetic disk device 2 includes N magnetic disks 11<0>, 11<1>, ..., and 11<N-1>, and each of the magnetic disks has recording surfaces on both sides (N is an integer of 1 or more). In this case, the arm 13 includes 2N arms 13<0>, 13<1>, 13<2>, 13<3>, ..., 13<2N-2>, and 13<2N-1>. The magnetic head 14 includes 2N magnetic heads 14<0>, 14<1>, 14<2>, 14<3>, ..., 14<2N-2>, and 14<2N-1>.

Each of the 2N magnetic heads 14<0> to 14<2N-1> corresponds to one recording surface. Therefore, in a case where a certain magnetic head 14 becomes unusable, the corresponding recording surface becomes unusable. In the Depop processing, a physical address space corresponding to the recording surface to be unusable is excluded from the association with a logical address space.

The hardware configuration of the magnetic disk device 2 will be described again with reference to FIG. 2.

The voice coil motor 15 is a motor that mechanically drives an object to be driven by the voice coil motor 15 based on an electric signal. The voice coil motor 15 moves the arm 13 along a radial direction of the magnetic disk 11. The radial direction of the magnetic disk 11 is a direction along the radius of the magnetic disk 11.

The motor driver 16 is a circuit that controls driving by the spindle motor 12 and driving by the voice coil motor 15. The motor driver 16 receives an electric signal and generates a control signal based on the received electric signal. The generated control signal includes information for controlling the driving of the spindle motor 12 and information for controlling the driving of the voice coil motor 15. The motor driver 16 has, for example, a form of an integrated circuit (IC) chip.

The head amplifier 17 is a circuit that executes processing for writing data to the magnetic disk 11 and reading data from the magnetic disk 11. The head amplifier 17 includes a read amplifier and a write driver. The read amplifier amplifies the read signal received from the read element 14r. The write driver generates a write current based on a signal based on the write data, and supplies the generated write current to the write element 14w. The head amplifier 17 has, for example, a form of an IC chip.

The RW channel 18 is a circuit that processes a signal. The RW channel 18 modulates (alternatively, converts to analog format) the write data received from the HDD controller 20 and generates a signal based on the write data. Then, the RW channel 18 supplies the generated signal to the write driver of the head amplifier 17. In addition, the RW channel 18 receives the amplified read signal from the head amplifier 17 and demodulates (alternatively, converts converted into a digital format) the received read signal to generate read data. Then, the RW channel 18 supplies the read data to the HDD controller 20.

The main controller 19 is an integrated circuit that controls the overall operation of the magnetic disk device 2. The main controller 19 includes a central processing unit (CPU), a random access memory (RAM), a read only memory (ROM), and the like. The RAM of the main controller 19 has a work area of the CPU of the main controller 19. The ROM of the main controller 19 may store programs and the like used by the magnetic disk device 2. The CPU of the main controller 19 may control the motor driver 16, the head amplifier 17, and the like and execute various operations by executing a program (alternatively, firmware) loaded from the ROM, the memory 21, or the RAM.

The HDD controller 20 is an interface that controls transmission and reception of signals between the magnetic disk device 2 and the host 3. The HDD controller 20 includes terminals (alternatively, a connector) to be connected to a circuit and wiring enabling communication with the host 3. The HDD controller 20 supplies the write data received from the host 3 to the RW channel 18. The HDD controller 20 receives read data from the RW channel 18 and transmits the read data to the host 3. The HDD controller 20 supplies a command received from the host 3 to the main controller 19. The HDD controller 20 transmits log information 22 stored in the memory 21 to the host 3. Some of the functions of the HDD controller 20 may be achieved by executing a program by the main controller 19.

The memory 21 is, for example, a non-volatile memory that stores data in a non-volatile manner. The memory 21 stores, for example, a program (alternatively, firmware) and control data for achieving some functions of the magnetic disk device 2 and controlling the magnetic disk device 2. For example, the memory 21 stores the log information 22.

The log information 22 is information obtained by extracting a part of an internal log acquired by regularly or irregularly monitoring the operation state of the magnetic disk device 2. The log information 22 may be stored not only in the memory 21, but also in the magnetic disk 11.

The internal log includes, for example, a large number of pieces of information such as a drive event log, a drive history log in which characteristic data is recorded in time series, a sense log, an environment event log, and a blocks event log.

The drive event log is information in which an event in the magnetic disk device 2 is recorded, and includes, for example, the number of read blocks and the write blocks for each magnetic head 14 and the number of retry occurrences of read, write, and seek operations for each retry step.

The drive history log is information in which characteristic data is recorded in time series, and includes environmental information such as the number of read blocks and the write blocks, the number of retry occurrences, a flying height, bit error rate (BER) measurement data, a temperature, a vibration occurrence state, and the like per unit time.

The sense log includes error sense information, an error occurrence time, and information in which a logical block address (LBA) and a cylinder head sector (CHS) indicating an error location are logged.

The environment event log is information in which a maximum value and a minimum value of each of an operating temperature and voltage are recorded.

The blocks event log is information in which the number of re-assign sectors and the number of pending sectors (bad block sectors) are recorded.

FIG. 4 is a diagram illustrating an example of a data structure of log information stored in the magnetic disk device according to the embodiment. As illustrated in FIG. 4, a part of the internal log as described above is included in the log information 22 as a plurality of entries each including a set of an address and a value.

The address is, for example, address information uniquely indicating a position where a corresponding value is stored.

The value is a specific numerical value acquired as an internal log by monitoring the operating state of the magnetic disk device 2.

For example, each of the plurality of entries corresponds to the number of occurrences of unrecovered errors, the number of occurrences of predetermined sense codes, and the flying height, retry count, and the number of read blocks of each of the 2N magnetic heads 14<0> to 14<2N-1>.

In the example of FIG. 4, the number of occurrences of unrecovered errors is stored in an address “0” as a value e0. The number of occurrences of a sense code “03-15-01” is stored in an address “1” as a value e1. The number of occurrences of a sense code “04-40-94” is stored in an address “2” as a value e2. The number of occurrences of a sense code “04-44-Dx” is stored in an address “3” as a value e3. The number of occurrences of a sense code “04-44-Ey” is stored in an address “4” as a value e4. The number of occurrences of a sense code “04-C4-zz” is stored in an address “5” as a value e5. The flying height of the (n+1)-th magnetic head 14<n> is stored in an address “5 + 3n + 1” as a value fn (0 ≤ n ≤ 2N-1). The retry count of a magnetic head 14<n> is stored in an address “5 + 3n + 2” as a value cn. The number of read blocks of a magnetic head 14<n> is stored in an address “5 + 3n + 3” as a value bn.

The sense code “04-44-Dx” indicates at least one sense code selected from eight sense codes “04-44-D0”, “04-44-D1”, “04-44-D2”, “04-44-D3”, “04-44-D4”, “04-44-D5”, “04-44-D6”, and “04-44-D7” (x is an integer of 0 or more and 7 or less). That is, the value e3 is the sum of the number of occurrences of at least one sense code selected from eight sense codes “04-44-D0”, “04-44-D1”, “04-44-D2”, “04-44-D3”, “04-44-D4”, “04-44-D5”, “04-44-D6”, and “04-44-D7”.

The sense code “04-44 Ey” indicates at least one sense code selected from the three sense codes “04-44-E0”, “04-44-E1”, and “04-44-E2” (y is an integer of 0 or more and 2 or less). That is, the value e4 is the sum of the number of occurrences of at least one sense code selected from three sense codes “04-44- E0”, “04-44-E1”, and “04-44-E2”.

The sense code “04-C4-zz” indicates at least one sense code selected from five sense codes “04-C4-00”, “04-C4-01”, “04-C4-04”, “04-C4-30”, and “04-C4-80” (zz is an integer representing 00, 01, 04, 30, or 80.). That is, the value e5 is the sum of the number of occurrences of at least one sense code selected from five sense codes “04-C4-00”, “04-C4-01”, “04-C4-04”, “04-C4 -30”, and “04-C4-80”.

Here, the sense codes “03-15-01”, “04-40-94”, “04-44-Dx”, “04-44-Ey”, and “04-C4-zz” are examples of codes representing the occurrence of a hard error. In the following description, a value calculated using at least one value selected from the values e1, e2,e3, e4, and e5 may also be referred to as the number of occurrences of hard errors or a hard error count.

As described above, a part of the internal log is selectively stored in the log information 22. As a result, the data size can be compressed as compared with a case where all the internal logs are included in the log information 22. Therefore, an increase in the transmission load of the log information 22 to the host 3 and the execution load of the determination processing are suppressed.

### 1.3 Host

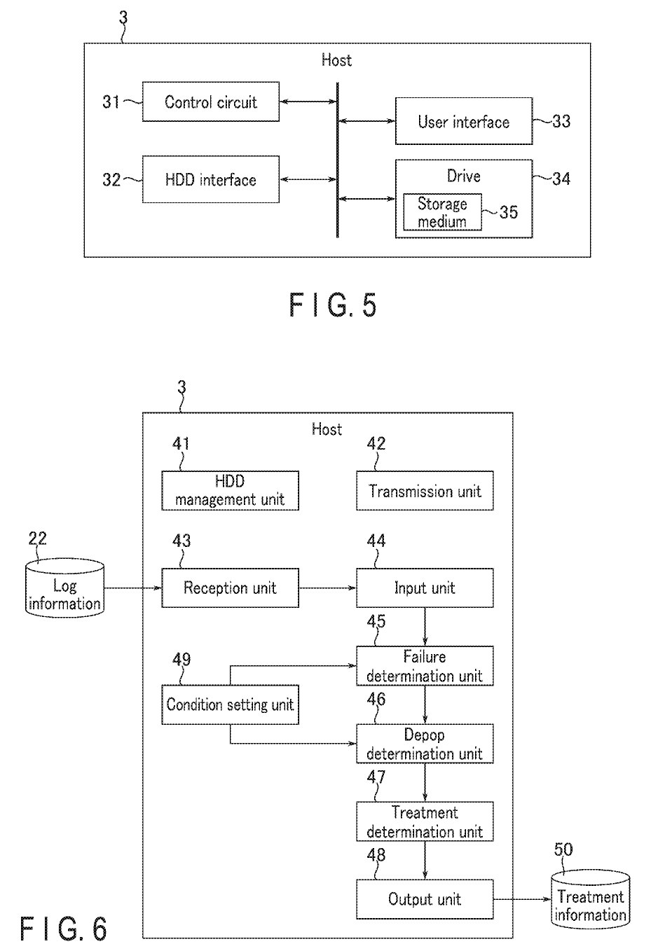

FIG. 5 is a block diagram illustrating an example of a hardware configuration of the host included in the data center system according to the embodiment.

As illustrated in FIG. 5, the host 3 includes, for example, a control circuit 31, an HDD interface 32, a user interface 33, and a drive 34. The drive 34 includes a storage medium 35.

The control circuit 31 is a circuit that entirely controls each component of the host 3. The control circuit 31 includes a central processing unit (CPU), a random access memory (RAM), a read only memory (ROM), and the like. The CPU of the control circuit 31 controls the entire host 3 according to a program stored in the ROM of the control circuit 31. The RAM of the control circuit 31 has a work area of the CPU of the control circuit 31. The ROM of the control circuit 31 stores programs and the like used by the host 3.

The HDD interface 32 is an interface that manages communication with the magnetic disk device 2. The HDD interface 32 includes, for example, a host bus adaptor (HBA).

The user interface 33 is an interface that manages communication with an operator of the data center system 1. The user interface 33 includes an input device and an output device. The input device includes, for example, a keyboard, a touch panel, an operation button, and the like. The output device includes, for example, a liquid crystal display (LCD) or an electroluminescence (EL) display, a printer, and the like. The output device can display, for example, the result of the determination processing on the display.

The drive 34 is a device for reading software stored in the storage medium 35. The drive 34 includes, for example, a drive such as a compact disk (CD) drive, a digital versatile disk (DVD) drive, an HDD, or a solid state drive (SSD).

The storage medium 35 is a medium that stores software by electrical, magnetic, optical, mechanical, or chemical action. The storage medium 35 may store a program used for the determination processing.

FIG. 6 is a block diagram illustrating an example of a functional configuration of the host included in the data center system according to the embodiment. As illustrated in FIG. 6, the control circuit 31 of the host 3 functions as a computer including an HDD management unit 41, a transmission unit 42, a reception unit 43, an input unit 44, a failure determination unit 45, a Depop determination unit 46, a treatment determination unit 47, an output unit 48, and a condition setting unit 49. In addition, the control circuit 31 of the host 3 generates the treatment information 50.

The HDD management unit 41 manages operation states of the plurality of magnetic disk devices 2. In a case where some anomaly is detected in the operation state of a certain magnetic disk device 2, the HDD management unit 41 takes the magnetic disk device 2 in which the anomaly is detected offline. Here, the anomaly detected by the HDD management unit 41 is not limited to the anomaly on the magnetic disk device 2 side, and includes other abnormalities on the host 3 side or in the data center system 1. Further, taking the target magnetic disk device 2 offline includes separating (excluding) the physical address space corresponding to the target magnetic disk device 2 from the logical address space without physically removing the target magnetic disk device 2 from the host 3 (that is, in a state of being physically connected to the host 3). As a result, writing and reading of data to and from the offline magnetic disk device 2 are not executed. The HDD management unit 41 issues a log acquisition command for requesting the log information 22 to the magnetic disk device 2 taken offline.

The transmission unit 42 transmits the log acquisition command to the offline magnetic disk device 2. When receiving the log acquisition command, the magnetic disk device 2 reads the log information 22 stored therein and transmits the log information to the host 3.

The reception unit 43 receives the log information 22 transmitted from the magnetic disk device 2. The reception unit 43 supplies the received log information 22 to the input unit 44.

Upon receiving the log information 22, the input unit 44 reads (inputs) the log information 22 for use in determination processing. In addition, the input unit 44 reads conditions to be applied to determination processing by the failure determination unit 45 and the Depop determination unit 46 to be described later from a table stored in the condition setting unit 49.

The failure determination unit 45 determines whether the offline magnetic disk device 2 has failed based on the read log information 22. Specifically, for example, the failure determination unit 45 may use the value e0 and the value (e1+e2+e3+e4+e5) as determination parameters. In this case, in a case where the value e0 exceeds a threshold Thr1 or the value (e1+e2+e3+e4+e5) exceeds a threshold Thr2, the failure determination unit 45 may determine that the offline magnetic disk device 2 has failed. In a case where the value e0 is equal to or less than the threshold Thr1 and the value (e1+e2+e3+e4+e5) is equal to or less than the threshold Thr2, the failure determination unit 45 may determine that the offline magnetic disk device 2 does not fail.

In a case where it is determined that the offline magnetic disk device 2 has not failed, the failure determination unit 45 supplies the determination result to the treatment determination unit 47. In a case where it is determined that the offline magnetic disk device 2 has failed, the failure determination unit 45 instructs the Depop determination unit 46 to perform further determination.

Upon receiving an instruction to perform further determination from the failure determination unit 45, the Depop determination unit 46 evaluates health states of all the magnetic heads 14<0> to 14<2N-1> included in the magnetic disk device 2 taken offline based on the read log information 22. As a result of the evaluation, the Depop determination unit 46 determines whether the magnetic head 14<n> having a deteriorated health state can be continuously used by the Depop processing. Specifically, for example, the Depop determination unit 46 may use the values fn, cn, and cn/bn as determination parameters. The value cn/bn indicates the retry rate of the magnetic head 14<n>.

In a case where the value fn exceeds a threshold Thr3, the value cn exceeds a threshold Thr4, or the value cn/bn exceeds a threshold Thr5, the Depop determination unit 46 may determine that the Depop processing for the (n+1)-th magnetic head 14<n> is recommended (contributed) to continuously use the magnetic disk device 2. In a case where the value fn is equal to or more than the threshold Thr3, the value cn is equal to or more than the threshold Thr4, and the value cn/bn is equal to or more than the threshold Thr5, the Depop determination unit 46 may determine that the Depop processing for the (n+1)-th magnetic head 14<n> is not recommended (not contributed) for continuous use of the magnetic disk device 2 that has been taken offline. The number of the magnetic heads 14<n> for which the Depop processing is recommended may be any number of 1 or more and 2N. Then, the Depop determination unit 46 supplies the determination result to the treatment determination unit 47.

The treatment determination unit 47 determines the treatment of the magnetic disk device 2 taken offline based on the determination results by the failure determination unit 45 and the Depop determination unit 46. In a case where the determination result indicating that there is no failure in the offline magnetic disk device 2 is received from the failure determination unit 45, the treatment determination unit 47 determines to continuously use the offline magnetic disk device 2 (return to service) and supplies the treatment information 50 including an instruction to continuously use to the output unit 48. In a case where the determination result indicating that there is the magnetic head 14<n> for which the Depop processing is recommended is received from the Depop determination unit 46, the treatment determination unit 47 determines continuous use after performing the Depop processing on the magnetic head 14<n>. Then, the treatment determination unit 47 supplies the output unit 48 with the treatment information 50 including the instruction for continuous use and the head number n of the magnetic head 14<n> for which the Depop processing has been recommended. In a case where the determination result indicating that there is no magnetic head 14<n> for which the Depop processing is recommended is received from the Depop determination unit 46, the treatment determination unit 47 determines to execute the replacement processing and supplies the treatment information 50 including an instruction to execute the replacement processing to the output unit 48. The replacement processing includes processing of physically removing the offline magnetic disk device 2 from the connection with the host 3 and replacing the offline magnetic disk device 2 with a spare magnetic disk device 2.

The failure determination unit 45 may further identify a failure mode based on the log information 22. For example, the failure determination unit 45 may identify the failure mode by determining whether a value calculated using at least one value selected from the values e0 to e5, fn, cn, and bn exceeds a predetermined threshold. In a case where the failure mode is identified, the failure determination unit 45 supplies the identified failure mode to the output unit 48.

In identifying the failure mode, the failure determination unit 45 may associate priority with a plurality of identified failure modes in advance. Then, in a case where a plurality of failure modes is identified, the failure determination unit 45 may supply the failure mode associated with the highest priority among the plurality of identified failure modes to the output unit 48.

The output unit 48 outputs the treatment information 50 from the treatment determination unit 47 to the operator of the data center system 1 via the user interface 33. Specifically, for example, upon receiving the treatment information 50 based on the determination result indicating that there is no failure, the output unit 48 outputs information indicating continuous use to the operator. Upon receiving the treatment information 50 based on the determination result indicating that there is a failure but the magnetic head 14<n> is continuously usable after the Depop processing, the output unit 48 outputs information indicating that the magnetic head is continuously used after the Depop processing and the number of the magnetic head to be subjected to the Depop processing = n to the operator. Upon receiving the treatment information 50 based on the determination result that there is a failure and the magnetic head 14<n> cannot be continuously used even by the Depop processing, the output unit 48 outputs to the operator that the replacement processing is performed.

The condition setting unit 49 stores a table for setting a determination parameter and a threshold used for determination by each of the failure determination unit 45 and the Depop determination unit 46. In the table corresponding to the determination example by the failure determination unit 45 described above, for example, a set of e0 and Thr1 and a set of (e1+e2+e3+e4+e5) and Thr2 are set as a set of a determination parameter and a threshold. In the table corresponding to the determination example by the above-described Depop determination unit 46, for example, a set of fn and Thr3, a set of cn and Thr4, and a set of cn/bn and Thr5 are set as a set of a determination parameter and a threshold. Then, the condition setting unit 49 has a function of changing the determination parameter and the threshold stored in the table. As a result, the operator is not limited to the specific examples described above, and can set the determination parameter based on any value in the log information 22. In addition, the operator can set any threshold for the set determination parameter. Therefore, a determination condition suitable for the operating environment of the data center system 1 can be set.

### 2. Operation

Next, an operation in the data center system 1 will be described.

### 2.1 Series of processing upon anomaly detection

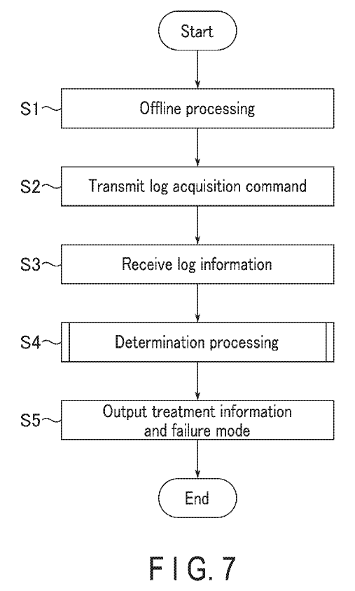

FIG. 7 is a flowchart illustrating an example of a series of processing executed when an anomaly is detected in the host included in the data center system according to the embodiment. In FIG. 7, it is assumed that the operator has set the determination parameter and the threshold used for the determination processing in advance via the condition setting unit 49.

When an anomaly is detected in a certain magnetic disk device 2 (start), the HDD management unit 41 takes the magnetic disk device 2 in which the anomaly is detected offline (S1).

The transmission unit 42 transmits the log acquisition command to the magnetic disk device 2 taken offline by the processing of S1 (S2). Upon receiving the log acquisition command, the magnetic disk device 2 transmits the log information 22 to the host 3.

The reception unit 43 receives the log information 22 from the magnetic disk device 2 (S3).

The input unit 44, the failure determination unit 45, the Depop determination unit 46, and the treatment determination unit 47 execute the determination processing based on the log information 22 received in the processing of S3 (S4). Details of the determination processing will be described later.

The output unit 48 outputs the treatment information 50 generated based on the processing of S4 to the operator (S5). In a case where the failure mode is identified in the determination processing to be described later, the identified failure mode may be output together with the treatment information 50.

Upon ending the processing of S5, a series of processing at the time of anomaly detection ends (ends).

### 2.2 Determination processing

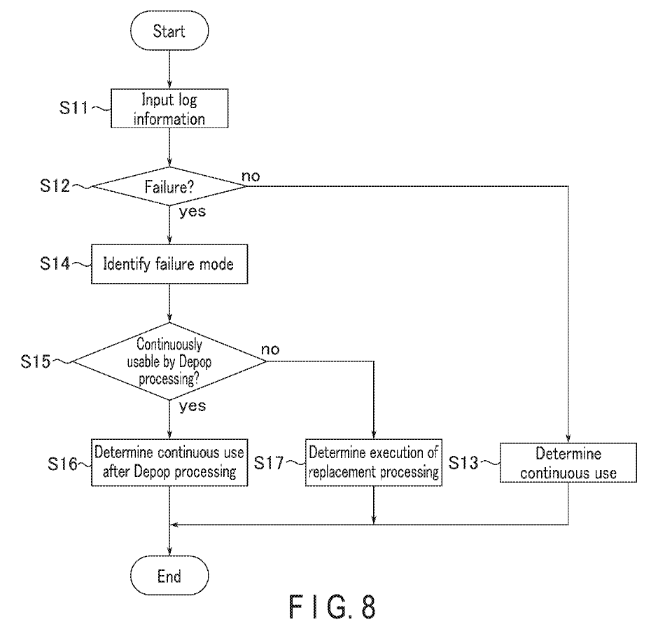

FIG. 8 is a flowchart illustrating an example of determination processing in the data center system according to the embodiment. The processing of S11 to S17 illustrated in FIG. 8 corresponds to the processing of S4 in FIG. 7.

Upon receiving the log information 22 (start), the input unit 44 reads the received log information 22 and the table storing the determination condition in such a way as to be usable in subsequent processing (S11).

The failure determination unit 45 determines whether there is a failure in the offline magnetic disk device 2 based on the log information 22 input in the processing of S11 (S12).

When it is determined that there is no failure in the offline magnetic disk device 2 (S12; no), the treatment determination unit 47 brings the offline magnetic disk device 2 online again without physically removing the offline magnetic disk device 2 and determines continuous use (S13). The treatment determination unit 47 supplies the output unit 48 with treatment information 50 indicating continuous use.

In a case where it is determined that there is a failure in the offline magnetic disk device 2 (S12; yes), the failure determination unit 45 identifies a failure mode (S14).

Based on the log information 22 input in the processing of S11, the Depop determination unit 46 determines whether the magnetic disk device 2 taken offline can be continuously used by the Depop processing (S15).

In a case where it is determined that the offline magnetic disk device 2 can be continuously used by the Depop processing (S15; yes), the treatment determination unit 47 determines continuous use after the Depop processing (S16). The treatment determination unit 47 supplies the output unit 48 with the failure mode identified in the processing of S14, the head number n of the magnetic head 14<n> for which the Depop processing is recommended, and the treatment information 50 indicating continuous use.

In a case where it is determined that the offline magnetic disk device 2 cannot be continuously used even by the Depop processing (S15; no), the treatment determination unit 47 determines to execute the replacement processing (S17). The treatment determination unit 47 supplies the output unit 48 with the failure mode identified in the processing of S14 and the treatment information 50 indicating that the replacement processing is to be performed (S17).

Upon ending the processing of S13, the processing of S16, or the processing of S17, the determination processing ends (ends).

### 3. Effects according to embodiments

According to the embodiment, the failure determination unit 45 determines whether there is a failure in the magnetic disk device 2 based on the log information 22 of the magnetic disk device 2. In a case where it is determined that the magnetic disk device 2 has failed as a result of the determination by the failure determination unit 45, the Depop determination unit 46 determines whether the magnetic disk device 2 can be continuously used by the Depop processing. The treatment determination unit 47 determines treatment of the magnetic disk device 2 based on the results of determination by the failure determination unit 45 and the Depop determination unit 46. As a result, when the magnetic disk device 2 operating in the data center system 1 is taken offline from the host 3 for some reason, a treatment for the magnetic disk device 2 can be determined without being physically separated from the host 3. Therefore, the number of times of occurrence of unnecessary replacement processing can be suppressed as compared with the case of replacement each time an anomaly is detected in the magnetic disk device 2.

In the determination by the failure determination unit 45, at least one value selected from the number of occurrences of unrecovered errors and the number of occurrences of hard errors can be used as a determination parameter. For the determination by the Depop determination unit 46, at least one value selected from the flying height, the retry count, and the retry rate can be used as a determination parameter. The condition setting unit 49 is configured to be able to change determination parameters and thresholds used for these determinations. As a result, it is possible to set an optimum determination parameter and threshold for each customer according to a difference in abnormal value determination criterion due to constraints such as performance and command latency imposed on the magnetic disk device 2 and a difference in failure mode due to an operation environment such as vibration and temperature of the magnetic disk device 2. Therefore, it is possible to accurately determine the magnetic head 14<n> for which the Depop processing is recommended. Therefore, the operation efficiency at the time of anomaly detection can be improved.

In addition, in a case where it is determined that there is a failure, the failure determination unit 45 identifies a failure mode of the magnetic disk device 2. As a result, the operator can grasp the tendency and distribution of the failure modes of the magnetic disk device 2 occurring in the data center system 1. Therefore, the operator can quickly cycle a PDCA cycle for improving the quality of the magnetic disk device 2.

### 4. Modifications and the like

Various modifications can be applied to the above-described embodiments.

In the above-described embodiment, the case where the determination processing is executed by the host 3 has been described, but the present invention is not limited thereto. For example, the determination processing may be executed by the magnetic disk device 2. That is, a program for executing the determination processing may be stored in the magnetic disk device 2.

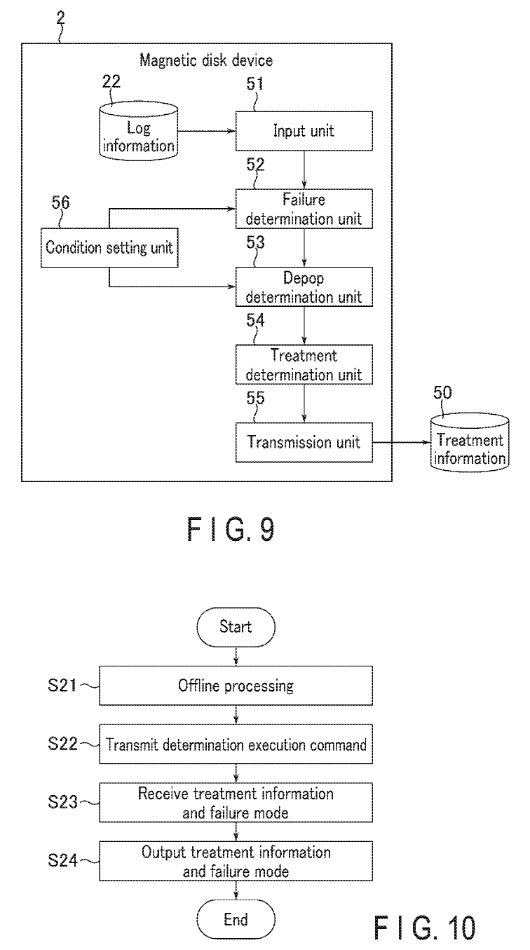

FIG. 9 is a block diagram illustrating an example of a functional configuration of a magnetic disk device included in a data center system according to a modification. As illustrated in FIG. 9, a main controller 19 of a magnetic disk device 2 functions as a computer including an input unit 51, a failure determination unit 52, a Depop determination unit 53, a treatment determination unit 54, a transmission unit 55, and a condition setting unit 56.

The input unit 51, the failure determination unit 52, the Depop determination unit 53, the treatment determination unit 54, and the condition setting unit 56 in the magnetic disk device 2 according to the modification can have functions comparable to those of the input unit 44, the failure determination unit 45, the Depop determination unit 46, the treatment determination unit 47, and the condition setting unit 49 in the host 3 according to the embodiment.

The input unit 51 reads the log information 22 from the memory 21 and the table related to the determination condition stored in the condition setting unit 56, and reads (inputs) the log information 22 for use in the determination processing.

The failure determination unit 52 determines whether its own magnetic disk device 2 has failed based on the read log information 22. In a case where it is determined that the own magnetic disk device 2 has not failed, the failure determination unit 52 supplies the determination result to the treatment determination unit 54. In a case where it is determined that the own magnetic disk device 2 has failed, the failure determination unit 52 instructs the Depop determination unit 53 to perform further determination.

Upon receiving an instruction to execute further determination from the failure determination unit 52, the Depop determination unit 53 determines whether its own magnetic disk device 2 can be continuously used by the Depop processing based on the read log information 22. Then, the Depop determination unit 53 supplies the determination result to the treatment determination unit 54.

The treatment determination unit 54 determines the treatment of its own magnetic disk device 2 based on the determination results by the failure determination unit 52 and the Depop determination unit 53. In the case of receiving a determination result indicating that there is no failure in the offline magnetic disk device 2 from the failure determination unit 52, the treatment determination unit 54 determines to continuously use its own magnetic disk device 2 and supplies the treatment information 50 including an instruction for continuous use to the transmission unit 55. In a case where a determination result indicating that there is the magnetic head 14<n> for which the Depop processing is recommended is received from the Depop determination unit 53, the treatment determination unit 54 determines continuous use after performing the Depop processing on the magnetic head 14<n>. Then, the treatment determination unit 54 supplies the transmission unit 55 with the treatment information 50 including the instruction for continuous use and the head number n of the magnetic head 14<n> for which the Depop processing has been recommended. In a case where the determination result indicating that there is no magnetic head 14<n> for which the Depop processing is recommended is received from the Depop determination unit 53, the treatment determination unit 54 determines to execute the replacement processing and supplies the treatment information 50 including an instruction to execute the replacement processing to the transmission unit 55.

The failure determination unit 52 may further identify the failure mode based on the log information 22 or the internal log. In a case where the failure mode is identified, the failure determination unit 52 supplies the identified failure mode to the transmission unit 55.

The transmission unit 55 transmits the treatment information 50 supplied from the treatment determination unit 54 to the host 3. In a case where the failure mode is supplied from the failure determination unit 52, the failure mode may be included in the treatment information 50.

The condition setting unit 56 stores a table for setting a determination parameter and a threshold used for determination by each of the failure determination unit 52 and the Depop determination unit 53. The condition setting unit 56 has a function of changing a determination parameter and a threshold used for various determinations executed by the failure determination unit 52 and the Depop determination unit 53.

In a case where the determination processing is executed in the magnetic disk device 2 with the above configuration, the HDD management unit 41 of the host 3 issues a determination execution command instructing execution of the determination processing. The transmission unit 42 transmits a determination execution command to the magnetic disk device 2. By receiving the determination execution command, the magnetic disk device 2 can execute the determination processing.

After execution of the determination processing by the magnetic disk device 2, the reception unit 43 of the host 3 receives the treatment information 50 from the magnetic disk device 2. Then, the output unit 48 outputs the treatment information 50 to the operator. In the case of receiving the failure mode together with the treatment information 50, the output unit 48 further outputs the failure mode to the operator.

FIG. 10 is a flowchart illustrating an example of a series of processing executed when an anomaly is detected in the host included in the data center system according to the modification. FIG. 10 corresponds to FIG. 7 in the embodiment.

Upon detecting an anomaly in a certain magnetic disk device 2 (start), the HDD management unit 41 takes the magnetic disk device 2 in which the anomaly is detected offline (S21).

The transmission unit 42 transmits the determination execution command to the magnetic disk device 2 taken offline by the processing of S21 (S22). Upon receiving the determination execution command, the input unit 51, the failure determination unit 52, the Depop determination unit 53, and the treatment determination unit 54 of the magnetic disk device 2 execute the determination processing based on the log information 22 in the memory 21. The determination processing executed by the magnetic disk device 2 is a processing comparable to the determination processing by the host 3 described with reference to FIG. 7 in the embodiment.

The reception unit 43 receives the treatment information 50 and the failure mode from the magnetic disk device 2 (S23).

The output unit 48 outputs the treatment information 50 and the failure mode received in the processing of S23 to the operator (S24).

Upon ending the processing of S24, a series of processing at the time of anomaly detection ends (ends).

According to the modification, the program for executing the determination processing is implemented in the magnetic disk device 2. The magnetic disk device 2 is configured to execute the determination processing in response to a determination execution command from the host 3. As a result, the magnetic disk device 2 can determine what kind of treatment is necessary for itself without being physically separated from the host 3. Therefore, as in the embodiment, it is possible to improve the operation efficiency at the time of anomaly detection as compared with the case of executing the replacement processing each time an anomaly is detected.

### 5. Others

In the embodiment and the modification described above, a case where a part of the internal log collected in the magnetic disk device 2 is extracted as the log information 22 has been described, but the present invention is not limited thereto. For example, the determination may be made using other information included in the internal log recorded in the magnetic disk 11.

As a result, the determination processing can be executed based on more information, and the accuracy of the determination processing can be improved. As described above, the determination processing is executed in the offline state without physically separating the magnetic disk device 2 from the host 3. Therefore, the modification can be applied without worrying about the restriction of the command response speed imposed in the online state within the range of the processing load allowed on the host 3 side.

In addition, in the above-described embodiment and modification, the case where the determination processing is executed in the data center system 1 has been described, but the present invention is not limited thereto. For example, the determination processing may be executed on a calculation resource on a cloud configured in a network (not illustrated) outside the data center system 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage medium storing a program for causing a computer to:
execute first processing of determining whether there is a failure in a magnetic disk device based on log information of the magnetic disk device;
in a case where it is determined in the first processing that the magnetic disk device has failed, execute second processing of determining whether the magnetic disk device is continuously used by depopulation processing; and
determine a treatment of the magnetic disk device based on results of the first processing and the second processing.

2. The storage medium according to claim 1, wherein
the first processing includes determining whether a first parameter based on the log information exceeds a first threshold, and
the first parameter is based on at least one value selected from the number of occurrences of unrecovered errors and the number of occurrences of hard errors.

3. The storage medium according to claim 1, wherein
the second processing includes determining whether a second parameter based on the log information exceeds a second threshold, and
the second parameter is based on at least one value selected from a flying height, a retry count, and a retry rate.

4. The storage medium according to claim 1, further storing a program for causing the computer to identify a failure mode of the magnetic disk device in a case where it is determined in the first processing that the magnetic disk device has failed.

5. The storage medium according to claim 1, wherein
the first processing includes determining whether a first parameter based on the log information exceeds a first threshold,
the second processing includes determining whether a second parameter based on the log information exceeds a second threshold, and
the storage medium further stores a program for causing the computer to change at least one value selected from the first parameter, the second parameter, the first threshold, and the second threshold.

6. The storage medium according to claim 1, wherein
the magnetic disk device is connected to a host and is in an off-line state with respect to the host, and
the treatment includes:
continuously using the magnetic disk device without physically removing the magnetic disk device from the host in a case where it is determined in the first processing that the magnetic disk device has not failed,
executing the depopulation processing and continuously using the magnetic disk device without physically removing the magnetic disk device from the host in a case where it is determined in the second processing that the magnetic disk device is continuously used by the depopulation processing, and
executing replacement processing in a case where it is determined in the second processing that the magnetic disk device is not continuously used by the depopulation processing.

7. The storage medium according to claim 6, further storing a program for causing the computer to output information indicating the treatment.

8. A magnetic disk device comprising a computer configured to execute determination processing in response to a command from a host, wherein
the determination processing includes:
executing first processing of determining whether there is a failure of the magnetic disk device based on log information;
executing second processing of determining whether the magnetic disk device is continuously used by depopulation processing in a case where it is determined in the first processing that the magnetic disk device has failed; and
determining a treatment of the magnetic disk device based on results of the first processing and the second processing.

9. The magnetic disk device according to claim 8, wherein
the first processing includes determining whether a first parameter based on the log information exceeds a first threshold, and
the first parameter is based on at least one value selected from the number of occurrences of unrecovered errors and the number of occurrences of hard errors.

10. The magnetic disk device according to claim 8, wherein
the second processing includes determining whether a second parameter based on the log information exceeds a second threshold, and
the second parameter is based on at least one value selected from a flying height, a retry count, and a retry rate.

11. The magnetic disk device according to claim 8, wherein the computer is further configured to identify a failure mode of the magnetic disk device in a case where it is determined in the first processing that the magnetic disk device has failed.

12. The magnetic disk device according to claim 8, wherein
the first processing includes determining whether a first parameter based on the log information exceeds a first threshold,
the second processing includes determining whether a second parameter based on the log information exceeds a second threshold, and
the computer is further configured to change at least one value selected from the first parameter, the second parameter, the first threshold, and the second threshold.

13. The magnetic disk device according to claim 8, wherein
the magnetic disk device is connected to a host and is in an off-line state with respect to the host, and
the treatment includes:
continuously using the magnetic disk device without physically removing the magnetic disk device from the host in a case where it is determined in the first processing that the magnetic disk device has not failed,
executing the depopulation processing and continuously using the magnetic disk device without physically removing the magnetic disk device from the host in a case where it is determined in the second processing that the magnetic disk device is continuously used by the depopulation processing, and
executing replacement processing in a case where it is determined in the second processing that the magnetic disk device is not continuously used by the depopulation processing.

14. A data center system comprising:
the magnetic disk device according to claim 8; and
the host.

15. A data center system comprising:
a magnetic disk device; and
a host, wherein
the host includes a computer configured to:
execute first processing of determining whether there is a failure in the magnetic disk device based on log information of the magnetic disk device;
in a case where it is determined in the first processing that the magnetic disk device has failed, execute second processing of determining whether the magnetic disk device is continuously used by depopulation processing; and
determine a treatment of the magnetic disk device based on results of the first processing and the second processing.
